(19) United States
(12) Patent Application Publication
(10) Pub. No.: US 2007/0084008 A1
(43) Pub. Date: Apr. 19, 2007

(54) Wiper spoiler

(75) Inventor: Robin Hwa, His Chih City (TW)

Correspondence Address: LEONG C LEI, PMB # 1008, 1867 YGNACIO VALLEY ROAD, WALNUT CREEK, CA, 94598, US

(73) Assignee: GREAT PERFORMANCE INDUSTRIES CO., LTD.

(21) Appl. No.: 11/249,430

(22) Filed: Oct. 14, 2005

(51) Int. Cl. B60S 1/38; B60Q 1/26

(52) U.S. Cl. 15/250.201; 15/250.001; 15/250.361; 362/503; 362/545

(57) ABSTRACT

A wiper spoiler is disclosed. The wiper spoiler a top cover having a battery recess at the center thereof and having a top edge mounted with a holding plate provided with a symmetrical elongated holes at the two lateral sides of the plate; a bottom cover having a cavity at the center of the cover and having two lateral sides provided with a securing slot; a circuit board positioned at the cavity of the bottom cover, and having two ends mounted respectively with different color LED; two transparent plates being mounted onto a securing slot of the bottom cover, having one end protruded to form an insertion section and having a protruded section on the surface thereof and corresponding to the elongated hole of the top cover; a pad mounted at the outer ring of the circuit board at the cavity of the bottom cover and having two ends respectively mounted with a mounting section having a mounting hole. The insertion section is mounted at the mounting hole such that when the top and the bottom cover are combined, and the protruded section is exposed from the elongated hole to form a spoiler for the wiper such that when the wiper is activated, the protruded section is flickered.

### BACKGROUND OF THE INVENTION

(a) Technical Field of the Invention

The present invention relates to wiper spoiler, and in particular, a wiper spoiler which provides a light flickering effect under insufficient light or in dark and when the wiper is activated.

(b) Description of the Prior Art

Windshield wipers are used in vehicles to clean or clear away water on the surface of the windshield of a vehicle so as to provide a clear vision to the driver while driving. Conventionally, the structure of a wiper is enhanced by providing a spoiler at the front edge of the wiper so that the wiper functions efficiently for wiping off water on the surface of the windshield. However, the conventional wiper, other than providing wiping of the windshield, does not give additional function to improve safety while driving. Accordingly, it is an object of the present invention to provide a wiper spoiler which not only function effectively in wiping away water on the windshield but also provides a flickering indication when the wiper is activated.

### SUMMARY OF THE INVENTION

The primary purpose of the present invention is to provide a wiper spoiler comprising a top cover having a battery recess at the center thereof and having a top edge mounted with a holding plate provided with symmetrical elongated holes at the two lateral sides of the holding plate; a bottom cover having a cavity provided at the center of the top cover and having two lateral sides provided with a securing slot; a circuit board positioned at the cavity of the bottom cover, and having two ends mounted respectively with different color LED; two transparent plates being mounted onto a securing slot of the bottom cover, and having one end protruded to form an insertion section and having a protruded section on the surface thereof and corresponding to the elongated hole of the top cover; a pad mounted at the outer ring of the circuit board at the cavity of the bottom cover and having two ends respectively mounted with a mounting section having a mounting hole; thereby the insertion section is mounted at the securing hole such that when the top and the bottom cover are assembled, and the protruded section is exposed from the elongated hole to form a spoiler for the wiper such that when the wiper is activated, the protruded section is flickered.

Yet still another object of the present invention is to provide a wiper spoiler, wherein the circuit board includes a light sensor element and a vibration sensor element such that when the wiper is activated, the LED on the circuit board is lighted.

A further object of the present invention is to provide a wiper spoiler, wherein the bottom edge of the two transparent plates is a continuous zigzag structure such that the illuminated light from LED is fully lighted as a result of the refraction of the zigzag structure.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the wiper spoiler of the present invention.

FIG. 2 is a perspective exploded view of the wiper spoiler of the present invention.

FIG. 3 is a schematic view showing the wiper spoiler being mounted onto the wiper in accordance with the present invention.

FIGS. 4 and 5 are schematic views showing the illumination of LED via the transparent plate in accordance with the present invention.

FIG. 6 is a view showing the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

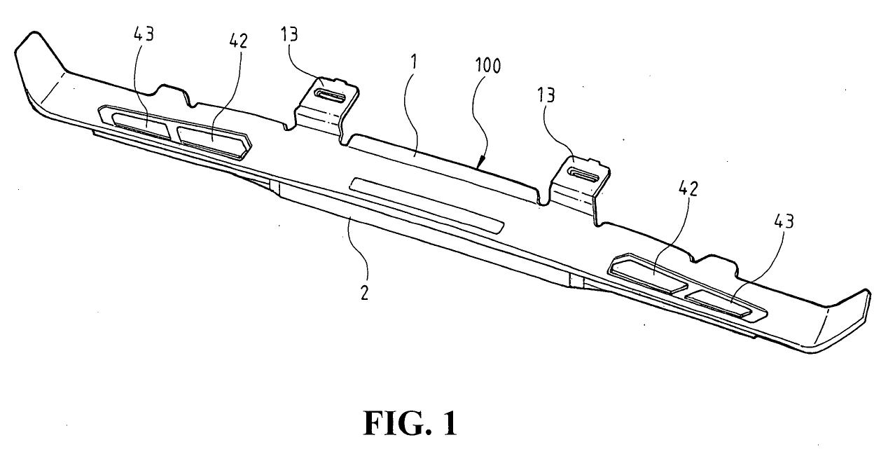

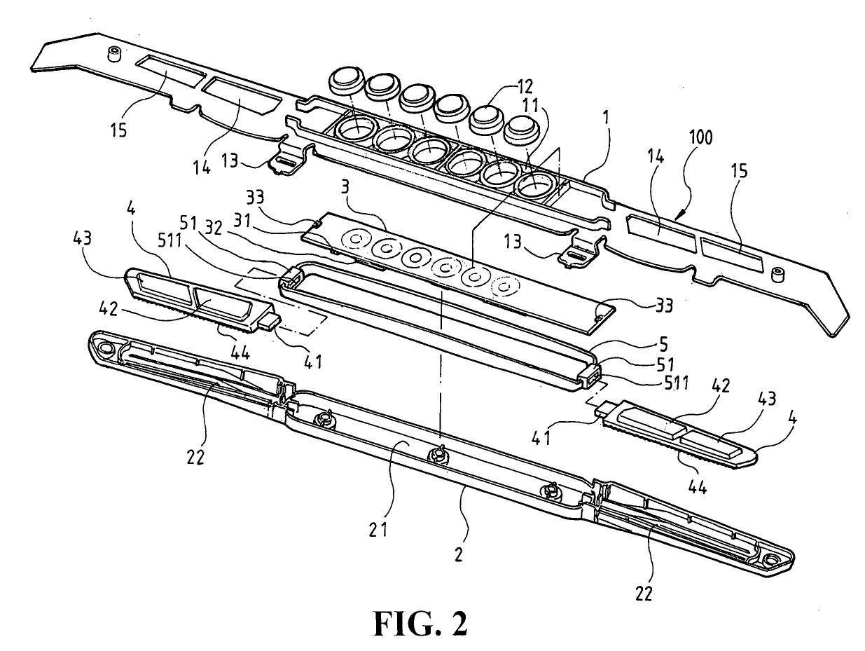

Referring to FIGS. 1 and 2, there is shown a wiper spoiler comprising a top cover 1 and a bottom cover 2. The center position of the top cover 1 is a recess 11 for storage of battery 12. (The battery recess 11 can be substituted with a battery clip). The top edge of the top cover 1 is provided with a holding plate 13, and the two lateral sides of the plate 13 are symmetrical elongated holes 14, 15.

The center position of the bottom cover 2 is provided with a cavity 21 for the storage of a circuit board 3. On the circuit board 3, there is provided a vibration sensor switch 31 and a light sensor element 32, and the two ends of the circuit board 3 are provided with LED 33. The two lateral sides of the bottom cover 2 are respectively provided with a securing slot 22 for the mounting of two transparent plates 4.

One end of the transparent plate 4 is protruded to form an insertion section 41. The surface of the transparent plate 4 is provided with two protruded sections 42, 43 corresponding to the elongated holes 14, 15 of the top cover 1. The bottom edge of the transparent plate 4 is a continuous zig zag structure 44.

In accordance with the present invention, the wiper spoiler has a pad 5 which is slightly larger than the circuit board 3, and the two ends of the pad 5 are respectively provided with a mounting section 51 having a mounting hole 511.

In assembly, the circuit board 3 is positioned at the cavity 21 of the bottom cover 2, and the pad 5 is positioned at the circumferential edge of the circuit board 3 to provide a water-proofing. The two transparent plates 4 are respectively inserted into the securing slots 22 at the two lateral sides of the bottom cover 2 such that the insertion section 41 of the transparent plate 4 is inserted into the mounting hole 511 of the mounting section 51. Thus, the LED 33 is corresponding to the insertion section 41. After that, the top and bottom cover 1, 2 are combined such that the protruded sections 42, 43 are exposed from the elongated holes 14, 15 forming into a spoiler 100 for mounting onto the wiper. Under poor light condition and when the wiper is activated, the light sensor element 32 and the vibration sensor switch 31 cause the LED 33 to be lighted so that light is illuminated to the transparent plate 4. The light is continuously refracted by the zig zag structure 44 of the transparent plate 4 so that the two transparent plates 4 are fully lighted and a flickering effect is obtained.

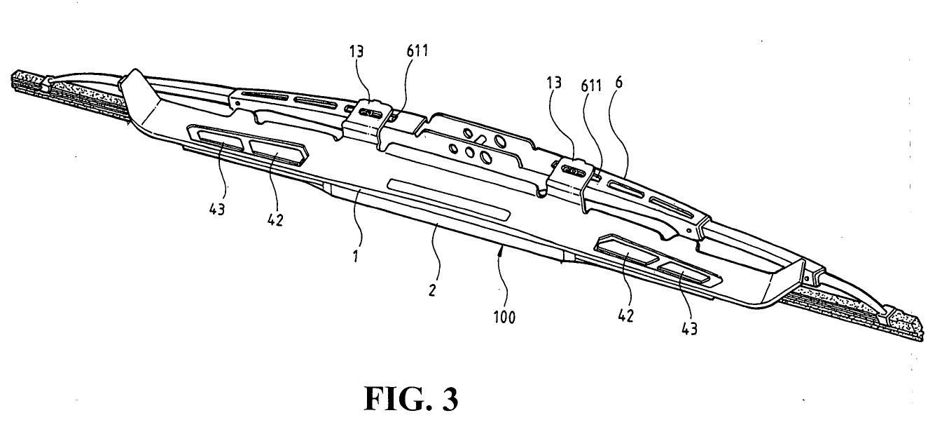

Referring to FIG. 3, when in application, the holding plate 13 is locked at the elongated hole 611 of the frame 61 of the wiper 6 such that when the wiper 6 moves and under poor visibility, the protruded sections 42, 43 of the transparent plates 43 generate flickered light.

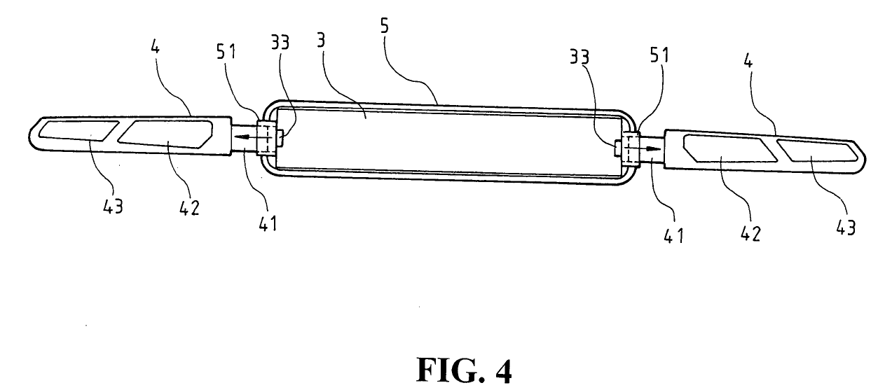

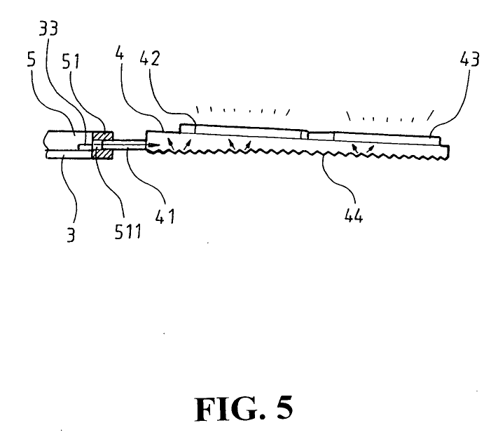

As shown in FIGS. 4 and 5, after the circuit board 3 is secured, the LED 33 is corresponding to the insertion 41 of the transparent plate 3 and the insertion section 41 of the transparent plate 41 is closely positioned at the LED 33. Thus, when LED 33 is lighted, it illuminates the transparent plate 4, and the pad 5 is functioned as a water-proofing device to prevent water leakage into the circuit board 3 and damaging the circuit board 3. The illuminated LED light ray provides continuous refraction by the zigzag structure 44 at the bottom edge of the transparent plate 4, such that the transparent plate 4 is fully lighted. The indication effect is enhanced.

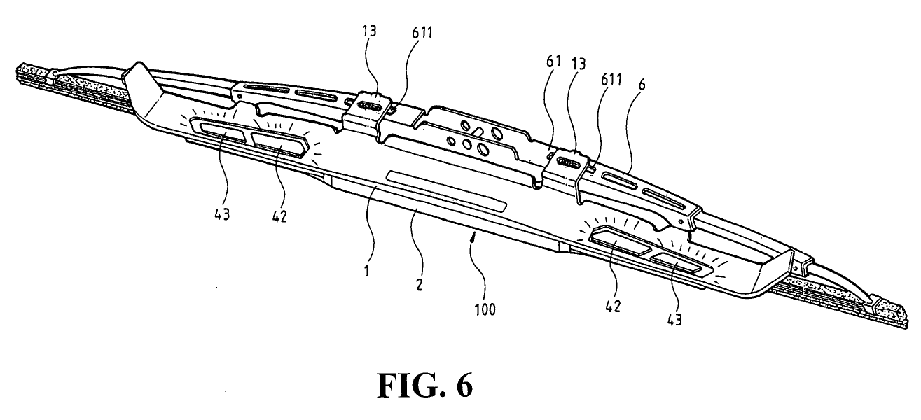

As shown in FIG. 6, after the wiper spoiler is mounted on the wiper, it provides smooth wiping to the wind shield, and under poor visibility condition, the protruded section 42, 43 of the transparent plates 4 are lighted and flickering. This will provide an improvement on the safety of driving.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wiper spoiler comprising
a top cover having a battery recess at the center thereof and having a top edge mounted with a holding plate provided with symmetrical elongated holes at the two lateral sides of the holding plate;
a bottom cover having a cavity at the center of the top cover and having two lateral sides provided with a securing slot;
a circuit board positioned at the cavity of the bottom cover, and having two ends mounted respectively with different color LED;
two transparent plates being mounted onto a securing slot of the bottom cover, having one end protruded to form an insertion section and having a protruded section on the surface thereof and corresponding to the elongated hole of the top cover;
a pad mounted at the outer ring of the circuit board at the cavity of the bottom cover and having two ends respectively mounted with a mounting section having a mounting hole;
thereby the insertion section is mounted at the mounting hole such that when the top and the bottom cover are combined, and the protruded section is exposed from the elongated hole to form a spoiler for the wiper such that when the wiper is activated, the protruded section is flickered.

2. The wiper spoiler of claim 1, wherein the circuit board includes a light sensor element and a vibration sensor switch such that when the wiper is activated, the LED on the circuit board is lighted.

3. The wiper spoiler of claim 1, wherein the bottom edge of the two transparent plates is a continuous zigzag structure such that the illuminated light from LED is fully lighted as a result of the refraction of the zigzag structure.
